(19) United States
(12) Patent Application Publication
(10) Pub. No.: US 2004/0245908 A1
(43) Pub. Date: Dec. 9, 2004

(54) Support frame structure, cathode ray tube, and manufacturing method of color selection structure

(76) Inventors: Keizou Makino, Tokyo (JP); Takafumi Kawasaki, Tokyo (JP); Yusuke Akiyama, Tokyo (JP)

Correspondence Address: BIRCH STEWART KOLASCH & BIRCH, PO BOX 747, FALLS CHURCH, VA, 22040-0747, US

(21) Appl. No.: 10/452,733

(22) Filed: Jun. 3, 2003

(51) Int. Cl. H01J 29/80

(52) U.S. Cl. 313/407

(57) ABSTRACT

Horizontal support bodies supporting a color selection electrode in horizontal direction are supported by vertical support bodies extending in vertical direction. The vertical support bodies have positioning holes, respectively, and the positioning holes are disposed in horizontal direction. Positioning pins are engaged in the positioning holes, respectively. The positioning pins move in horizontal direction so that the support frame structure is positioned in horizontal direction and vertical direction.

### BACKGROUND OF THE INVENTION

1. Field of the Invention

The present invention relates to a method of manufacturing a color selection structure for cathode ray tube and, in particular, to a technique of lightening a color selection structure and improving its productivity.

2. Description of the Background Art

As a color selection structure for cathode ray tube, a structure employing shadow mask is known. There is also known one technique in which a color selection electrode with a large number of slots and holes formed by pressing a metal plate is fixed to a support frame structure, and other technique in which a color selection electrode with a large number of slits formed by selectively etching a metal plate (i.e., an aperture grill) is hung and stretched on a support frame structure (hereinafter referred to as “stretch mask technique”).

FIG. 14 is a perspective view showing the construction of major parts of a color selection structure 200 employed in stretch mask technique. In the following description, a direction in which vertical scanning is performed, a direction in which horizontal scanning is performed, and a direction in which electron beam travels primarily when the color selection structure 200 is disposed in a cathode ray tube, are hereinafter referred to as “vertical direction V,” “horizontal direction H” and “traveling direction Z,” respectively. It is noted that traveling direction Z is orthogonal to vertical direction V and horizontal direction H, respectively. FIG. 15 shows a bottom view when the color selection structure 200 is viewed in traveling direction Z.

The color selection structure 200 has an aperture grill 20 and a support frame structure 201. The support frame structure 201 has a horizontal support pair 12 for supporting the aperture grill 20 in horizontal direction H, and a vertical support pair 11 for supporting the horizontal support pair 12. The horizontal support pair 12 has horizontal support bodies 12a and 12b, each extending in horizontal direction H. The vertical support pair 11 has vertical support bodies 11a and 11b, each extending in vertical direction V.

The aperture grill 20 is fixed to the horizontal support pair 12 by seam welding on a track 21. The horizontal support pair 12 is fixed to the vertical support pair 12 by welding. In order to maintain the state that the aperture grill 20 is stretched by the horizontal support pair 12, the horizontal support bodies 12a and 12b are made of a metal plate having a thickness of 4 to 5 mm and an L-shape cross section, and the vertical support bodies 11a and 11b are made of a metal pillar having a 10-20 mm square cross section. As the result, the support frame structure 201 is a considerable weight.

FIGS. 16 to 20 are conceptual diagrams showing the steps of welding the aperture grill 20 to the support frame structure 201. Firstly, the support frame structure 201 provided with the vertical support pair 11 and horizontal support pair 12 that are mutually fixed by welding is positioned in horizontal direction H. Specifically, as shown in FIG. 16, for example, a positioner 31 is disposed between the vertical support bodies 11a and 11b. With the positioner 31, the support frame structure 201 is moved in two directions parallel to horizontal direction H, as indicated by a double-headed arrow, so that the support frame structure 201 is positioned in horizontal direction H.

Subsequently, the support frame structure 201 is positioned in vertical direction V. Specifically, as shown in FIG. 17, for example, a positioner 32 pushes the horizontal support body 12a. With the positioner 32, the support frame structure 201 is moved in a direction opposed to and parallel to vertical direction V, as indicated by an arrow, so that the support frame structure 201 is positioned in vertical direction V.

Subsequently, the support frame structure 201 is positioned in traveling direction Z. Specifically, as shown in FIG. 18, for example, press 101 is applied to the support frame structure 201 such that the support frame structure 201 moves in traveling direction Z until the horizontal support pair 12 abuts a positioner 33. In FIG. 18, the respective planes of the horizontal support bodies 12a and 12b which abut the positioner 33, namely, the planes of the horizontal support bodies 12a and 12b which are the remotest from the vertical support bodies 11a and 11b, are designated by planes 12ar and 12br, respectively. For example, a cylindrical roller having a central axis parallel to vertical direction V is used as the positioner 33.

Thereafter, as shown in FIG. 19, press 102 is applied such that the horizontal support bodies 12a and 12b approach each other. Thereby, the vertical support bodies 11a and 1b urge the horizontal support bodies 12a and 12b such that the horizontal support bodies 12a and 12b depart from each other. Referring to FIG. 20, in the state that press 102 is applied, press 103 is applied to the support frame structure 201 so as to move in traveling direction Z. As the result, the horizontal support pair 12 abuts the aperture grill 20 fixed on a plane to be determined by horizontal direction H and vertical direction V. Then, the aperture grill 20 is fixed by seam welding to the planes 12ar and 12br along the track 21.

When the application of the press 102 is stopped, the vertical support bodies 11a and 11b urge the horizontal support bodies 12a and 12b, respectively, so that the aperture grill 20 is stretched by tensile force in vertical direction V.

Recently, it has been required to lighten cathode ray tubes because of the demands for matching to market desire, resources saving and cost reduction. To meet these demands, it is necessary to reduce the weight of individual components, and color selection structures are no exceptions.

A support frame structure accounts for most of the weight of a color selection structure. Particularly in stretch mask technique, as described above, the support frame structure 201 supports and fixes the aperture grill 20 in the state that tensile force in vertical direction V is applied to the aperture grill 20 serving as a color selection electrode. Therefore, the support frame structure 201 is required to have high enough toughness to resist to this tensile force, and the support frame structure 201 is therefore required to be stronger than the case with other techniques. To meet this demand, the support frame structure 201 of stretch mask technique is constructed by using a metal plate, metallic pipe, and metal pillar that are relatively heavy, as previously described.

That is, in order to reduce the weight of the color selection structure, it is essential to achieve a lightweight support frame structure. Reducing the weight of the support frame structure while employing a conventional technique may deteriorate toughness and further cause deformation of a color selection electrode fixed to the support frame structure.

Further, a lightweight support frame structure is likely to be instable in the steps shown in FIGS. 16 and 17, namely, the positioning in vertical direction V and horizontal direction H. Additionally, when the thickness of the horizontal support bodies 12a and 12b is reduced for lightning, the planes 12ar and 12br are narrowed so that the area of seam welding is reduced. Therefore, a higher accuracy positioning technique than earlier is demanded when lightening the support frame structure.

Furthermore, when the support frame structure 201 abuts the positioner 33 in the step shown in FIG. 18, thin horizontal support bodies 12a and 12b may deform to affect the positioning accuracy in the support frame structure 201 as a whole. This makes impossible to secure the normal track 21. As the result, the electrode might depart during the seam welding, and the effective area of picture on which phosphor is applied might tilt or deviate with respect to the panel external shape. Especially, high dimensional accuracy is required for the planes 12ar and 12br of the horizontal support bodies 12a and 12b because these planes support the color selection electrode. If the planes 12ar and 12br are deformed, wrinkling might occur in the aperture grill 20 during the time of seam welding. The wrinkling causes a local deformation in the stripe width of the aperture grill 20, and the local deformation and the phosphor employing a black matrix combine to give non-uniformity in density, thereby giving discomfort to the user of the cathode ray tube.

### SUMMARY OF THE INVENTION

It is an object of the present invention to provide a technique of obtaining a color selection structure for cathode ray tube that is more lightweight and quality stable than earlier.

A support frame structure according to the present invention supports a color selection electrode for cathode ray tube in first and second directions orthogonal to each other. The support frame structure includes a first direction support pair and a second direction support pair. The first direction support pair supports the color selection electrode in the first direction. The second direction support pair supports the first direction support pair. The first direction support pair has a pair of first direction support bodies. Each of the pair of first direction support bodies extends in the first direction. The second direction support pair has a pair of second direction support bodies. Each of the pair of second direction support bodies extends in the second direction. Each of the pair of second support bodies has a hole. A pair of the holes is disposed in the first direction.

The support frame structure can be positioned easily in the first and second directions by engaging positioning pins in the holes.

In a first method of manufacturing a color selection structure according to the present invention, the color selection structure includes a color selection electrode for cathode ray tube and a support frame structure supporting the color selection electrode. The support frame structure has a first direction support pair and a second direction support pair. The first support pair supports the color selection electrode in a first direction. The second direction support pair supports the first direction support pair. The first direction support pair has a pair of first direction support bodies. Each of the first direction support bodies extends in the first direction. The second direction support pair has a pair of second direction support bodies. Each of the second direction support bodies extends in a second direction orthogonal to the first direction. Each of the second direction support bodies has a hole. A pair of the holes is disposed in the first direction. The method includes the steps (a) to (c). In the step (a), a pair of the positioning pins is positioned in a pair of the holes. In the step (b), after the step (a), the pair of positioning pins is moved so as to depart from each other in a direction parallel to the first direction. In the step (c), after the step (b), a first plane of the first direction support bodies is allowed to support the color selection electrode.

It is easy to position the support frame structure in the first and second directions.

A second method of manufacturing a color selection structure according to the present invention includes the steps of (a) and (b). In the step (a), a support frame structure is annealed. In the step (b), the support frame structure is allowed to support a color selection electrode for cathode ray tube.

The mechanical strength of the support frame structure can be increased by conducting heat treatment to the support frame structure before supporting the color selection electrode. Therefore, a thin metal plate, which permits lightening, is usable as a member constructing the support frame structure.

A cathode ray tube according to the present invention includes a support frame structure of the present invention, a color selection electrode, a phosphor, and an electron gun that irradiates electron beam to the phosphor through the color selection structure.

The weight of the cathode ray tube can be reduced while maintaining a good quality thereof.

In a method of manufacturing a cathode ray tube according to the present invention, the first method of manufacturing a color selection structure or the second method of manufacturing a color selection structure is employed to manufacture a cathode ray tube having a color selection structure, a phosphor, and an electron gun that irradiates electron beam to the phosphor through the color selection structure.

The weight of the cathode ray tube can be reduced while maintaining a good quality thereof.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual diagram showing the construction of a support frame structure according to a first preferred embodiment of the present invention;

FIG. 2 is a bottom view of the support frame structure of the first preferred embodiment;

FIG. 3 is an enlarged detail of part of FIG. 2;

FIGS. 4 and 5 are conceptual diagrams showing positioning of the support frame structure in horizontal and vertical directions in the first preferred embodiment;

FIG. 6 is a conceptual diagram showing positioning of the support frame structure in traveling direction in the first preferred embodiment;

FIG. 7 is a conceptual diagram showing positioning of a support frame structure in traveling direction according to a second preferred embodiment of the invention;

FIG. 8 is a diagram showing the construction of a support frame structure according to a third preferred embodiment of the invention;

FIG. 9 is a diagram showing a method of manufacturing a color selection structure according to a fourth preferred embodiment of the invention;

FIGS. 10 and 11 are conceptual diagrams showing a method of manufacturing a color selection construction according to a fifth preferred embodiment of the invention;

FIG. 12 is a perspective view showing the construction of a color selection structure;

FIG. 13 is a perspective view showing the construction of a cathode ray tube according to the present invention;

FIG. 14 is a perspective view showing the construction of a color selection structure according to a conventional technique;

FIG. 15 is a bottom view showing the construction of the conventional color selection structure; and

FIGS. 16 to 20 are conceptual diagrams showing the manufacturing steps of a color selection structure according to a conventional technique.

### DESCRIPTION OF THE PREFERRED EMBODIMENTS

First Preferred Embodiment

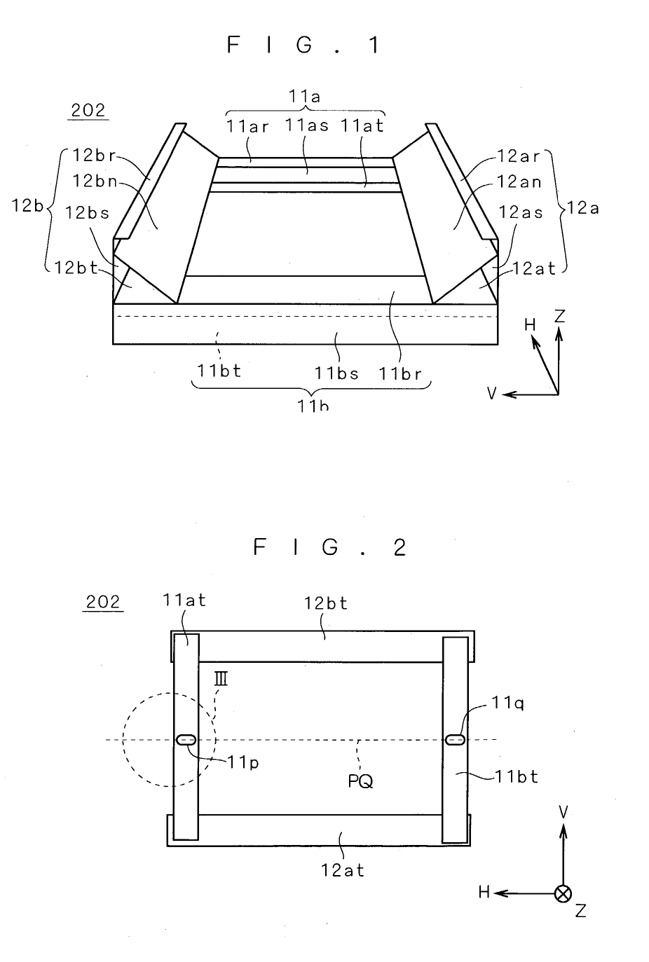

FIG. 1 is a conceptual diagram showing the construction of a support frame structure 202 according to a first preferred embodiment of the present invention. As in the support frame construction 201, the support frame structure 202 has a horizontal support pair 12 for supporting an aperture grill in horizontal direction H, and a vertical support pair 11 for supporting the horizontal support pair 12. The support frame structure 202 has a horizontal support bodies 12a and 12b, each extending in horizontal direction H. The vertical support pair 11 has vertical support bodies 11a and 11b, each extending in vertical direction V. For example, the vertical support pair 11 and horizontal support pair 12 are fixed by welding.

This preferred embodiment is different from the conventional technique in the construction of the horizontal support bodies 12a and 12b and the vertical support bodies 11a and 11b. The horizontal support body 12a has planes 12ar and 12 at vertical to traveling direction Z, a plane 12 as vertical to vertical direction V, and a plane 12an that is parallel to horizontal direction H and tilts in both of vertical direction V and traveling direction Z. The planes 12ar, 12as, 12at and 12an are joined in the order named. For example, the horizontal support body 12a is obtainable by bending a metal plate. The horizontal support body 12b has planes 12br and 12bt vertical to traveling direction Z, a plane 12bs vertical to vertical direction V, and a plane 12bn that is parallel to horizontal direction H and tilts in both of vertical direction V and traveling direction Z. The planes 12br, 12bs, 12bt and 12bn are joined in the order named. For example, the horizontal support body 12b is obtainable by bending a metal plate. The angle formed by the planes 12an and 12 at is opposed to the angle formed by the planes 12bn and 12bt.

The vertical support body 11a has planes liar and 11at vertical to traveling direction Z, and a plane 11as vertical to horizontal direction H. The planes 11ar, 11as and 11at are joined in the order named. For example, the vertical support body 11a is obtainable by bending a metal plate so as to have two approximately ninety bends. The vertical support body 11b has planes 11br and 11bt vertical to traveling direction Z, and a plane 11bs vertical to horizontal direction H. The planes 11br, 11bs and 11bt are joined in the order named. For example, the vertical support body 11b is obtainable by bending a metal plate so as to have two approximately ninety bends. The planes 11ar and 11at are disposed more inside with respect to the support frame structure 202 than the plane 11as, and the planes 11br and 11bt are disposed more inside with respect to support frame structure 202 than the plane 11bs.

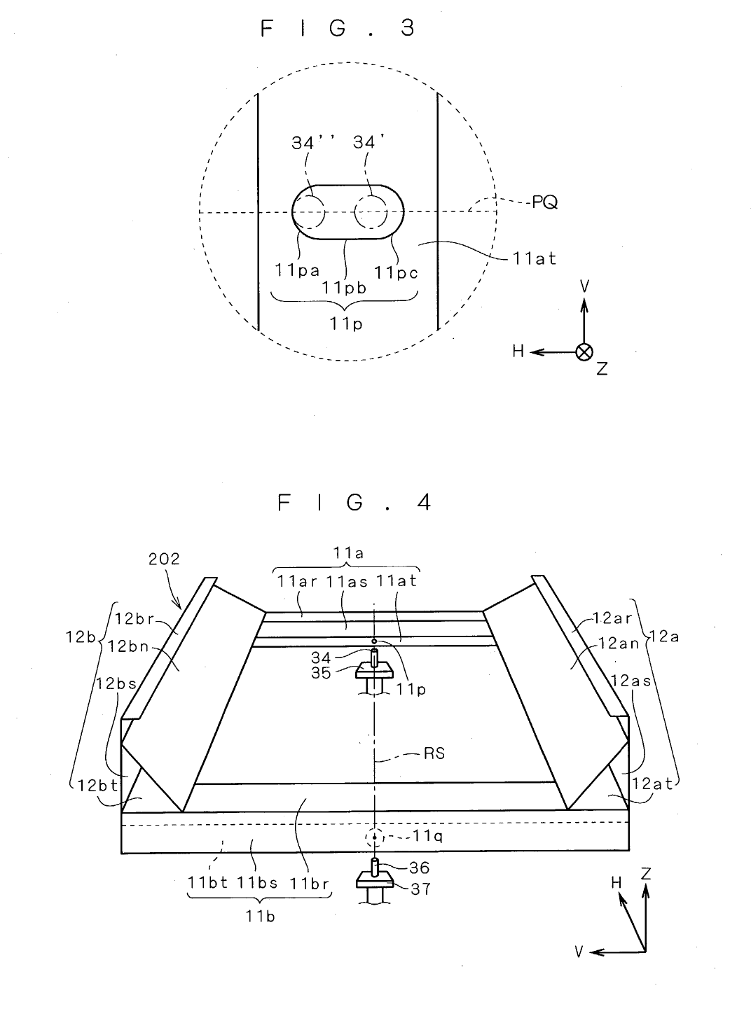

FIG. 2 is a bottom view when the support frame structure 202 is viewed in traveling direction Z. The end parts of the planes 12 at and 12bt of the horizontal support pair 12 in horizontal direction H are welded to the end parts of the planes lar and 11br of the vertical support pair 11 in vertical direction V. As a whole, the support frame structure 202 has a rectangular-shape in the plane vertical to traveling direction Z.

Since the horizontal support bodies 12a and 12b are formed by bending a metal plate as described above, even if the metal plate is thinned for lightening, it is possible to fix the planes 12ar and 12br for supporting the aperture grill and also suppress a reduction in toughness. In particular, it is possible to suppress a reduction in toughness of the horizontal support bodies 12a and 12b by supporting for example by welding the end parts of the planes 12an and 12bn opposed to the planes 12 at and 12bt, to the planes 12 as and 12bs, respectively.

Since the vertical support bodies 11a and 11b can also be formed by bending a metal plate as described above, even if the metal plate is thinned for lightening, toughness needed for stretching the aperture grill in vertical direction V can be secured. This eliminates the problem that the aperture grill fixed to the support frame structure 202 suffers from deformation. For example, the thickness of the metal plate is settable to 1.5 to 2.0 mm.

The planes 11at and 11bt of the vertical support bodies 11a and 11b have positioning holes 11p and 11q, respectively. The positioning holes 11p and 11q are used for positioning in horizontal direction H and vertical direction V, and they are disposed on a virtual line PQ in approximately the center of the vertical support bodies 11a and 11b, respectively.

FIG. 3 is an enlarged view showing a detail of part III in FIG. 2. The contour of the positioning hole 11p has circular arc parts 11pa and 11pc, and a linear part 11pb joining the circular arc parts 11pa and 11pc and extending in horizontal direction H. The circular arc part 11pa joins the linear part 11pb on the opposite side to the vertical support body 11b. The center of a circle including the circular arc parts 11pa and 11pc is located approximately on the virtual line PQ, and the linear part 11pb is disposed on the virtual line PQ and therefore parallel to horizontal direction H. The positioning hole 11q is formed in the same shape as the positioning hole 11p.

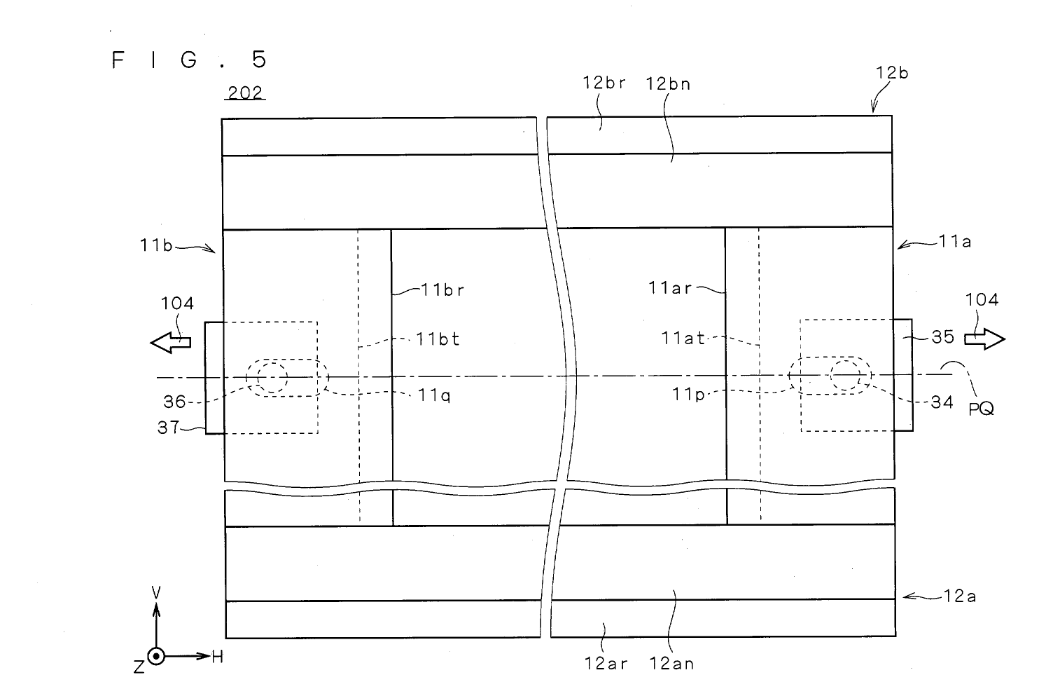

FIGS. 4 and 5 are conceptual diagrams showing a method of positioning the support frame structure 202 in horizontal direction H and vertical direction V. Referring to FIG. 4, with respect to the support frame structure 202, positioning pins 34 and 36 travel in traveling direction Z (an upward direction here) and are engaged in the positioning holes 11p and 11q, respectively. Line RS connecting the positioning pins 34 and 36 is approximately parallel to horizontal direction H. The positioning pins 34 and 36 traveling in traveling direction Z is temporarily stopped when pedestals 35 and 37, which are disposed with respect to the positioning pins 34 and 36 in the opposite direction to traveling direction Z, abut the planes 11at and 11bt, respectively.

FIG. 3 shows position 34′ of the positioning pin 34 when the positioning pin 34 is engaged in the positioning hole 11p. The contour of the positioning hole 11p has a linear part 11pb, and there is room for the location of the positioning pin 34 in horizontal direction H, thereby making it easy to engage the positioning pin 34 in the positioning hole 11p. Increasing the diameter of the circular arc parts 11pa and 11pc than the diameter of the positioning pin 34 allows room for the location of the positioning pin 34 in vertical direction V.

Referring to FIG. 5, in the state that the positioning pins 34 and 36 are engaged in the positioning holes 11p and 11q, respectively, force 104 is applied such that the positioning pins 34 and 36 depart from each other in a direction parallel to horizontal direction H. Since the contour of the positioning hole 11p has the linear part 11pb, the positioning pin 34 moves in horizontal direction H and reaches position 34″ inscribed to the circular arc part 11pa shown in FIG. 3. Likewise, the positioning pin 36 is inscribed (not shown) to a circular arc part of the positioning hole 11q which is the remotest from the vertical support body 11a. This permits a stable, reliable and accurate positioning of the support frame structure 202 in horizontal direction H and vertical direction V.

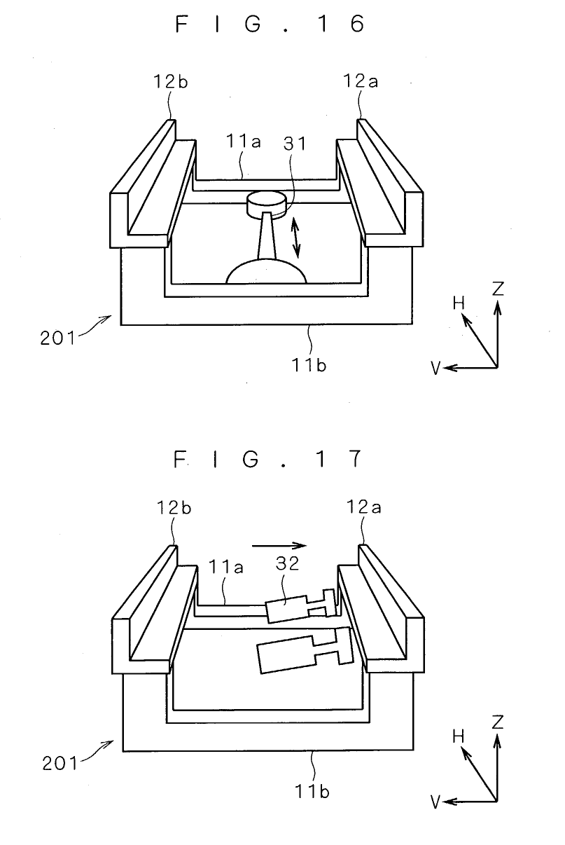

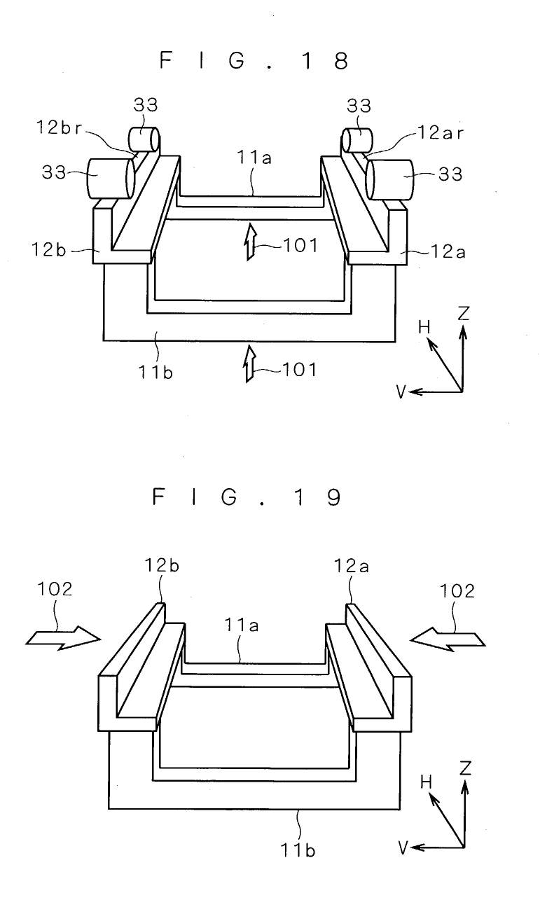

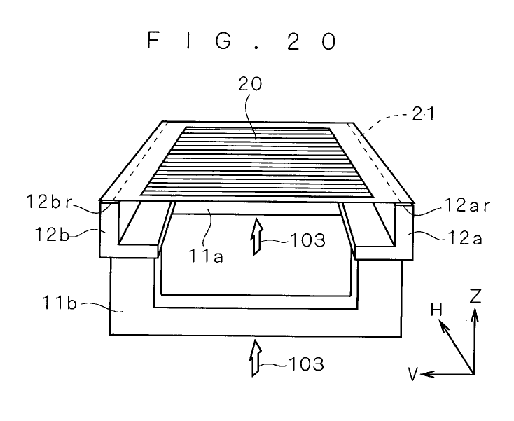

In addition, as compared to the conventional technique using two mechanisms of the positioner 31 (FIG. 16) and the positioner 32 (FIG. 17) for positioning in horizontal direction H and vertical direction V, the method of this preferred embodiment has the advantage of being stable and easy to adjust because a single mechanism performs positioning in horizontal direction H and vertical direction V.

When positioning in horizontal direction H and vertical direction V is completed, the positioning pins 34 and 36 resume their travel in traveling direction Z.

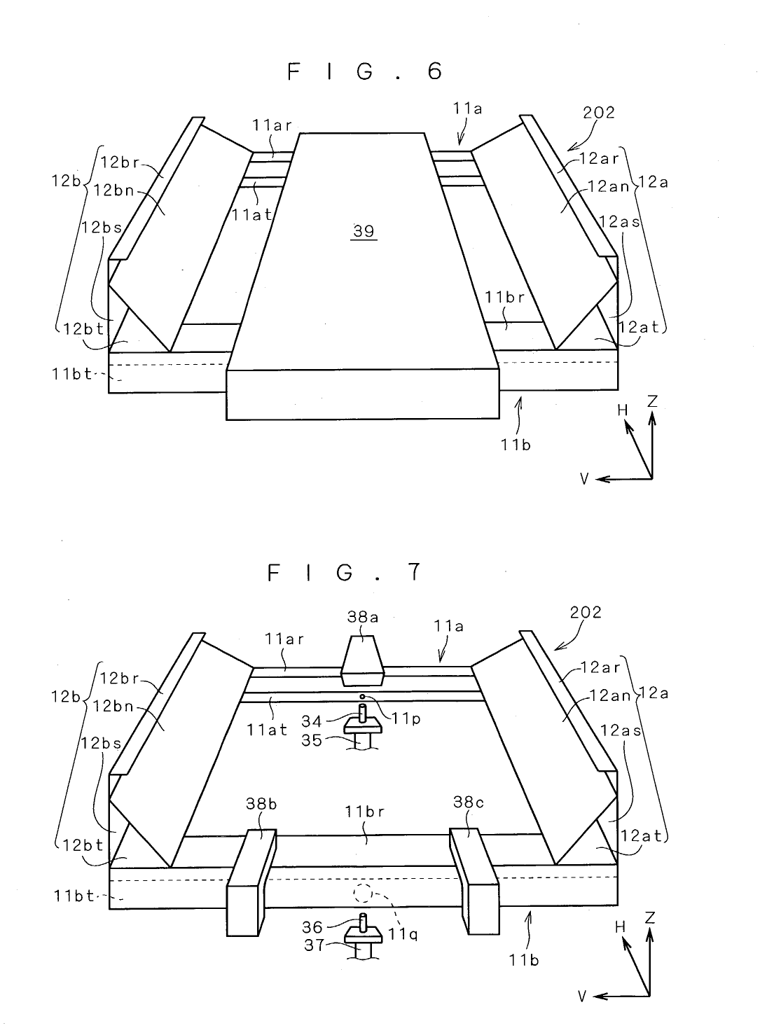

FIG. 6 is a conceptual diagram showing a method of positioning the support frame structure 202 in traveling direction Z. Until the planes lar and 11br of the vertical support body 11 abut a plate-like positioner 39, the pedestals 35 and 37 (which are hidden beneath a positioner 39 in FIG. 6) push up the planes 11at and 11bt in traveling direction Z such that the support frame structure 202 moves in traveling direction Z.

Thereafter, in the same manner as in the conventional technique, an aperture grill (not shown) is fixed to the planes 12ar and 12br by seam welding, while applying press such that the horizontal support bodies 12a and 12b approach each other. A greater diameter of the circular arc parts 11pa and 11pc than the diameter of the positioning pin 34 allows more room for the vertical support bodies 11a and 11b elastically deformed by the press applied such that the horizontal support bodies 12a and 12b approach each other. Then, when the application of press is stopped, based on the elastic deformation, the vertical support bodies 11a and 11b urge the horizontal support bodies 12a and 12b, so that press in vertical direction V is applied to the aperture grill (not shown) so as to stretch the aperture grill.

In the case of positioning the support frame structure 202 in traveling direction Z, unlike the conventional technique, the planes 1ar and 11br of the vertical support pair 11 abut the positioner 39, instead of the planes 12ar and 12br of the horizontal support pair 12. It is therefore less likely to deform the horizontal support bodies 12a and 12b, or deteriorate positioning accuracy in the support frame structure 202.

Even if some deformation occurs in the horizontal support pair 12, its deformation can be suppressed because seam welding is performed while pushing it up to the aperture grill.

A greater distance between the positioning holes 11p and 11q is more desirable to render the support frame structure 202 difficult to rotate when the force 104 is applied.

In the color selection structure including the support frame structure 202 so obtained and the aperture grill, dimensional accuracy is improved by about 40%, as compared to the case that the vertical support pair 11 and horizontal support pair 12 are formed by bending a metal plate, as in this preferred embodiment, and positioning is performed with the conventional technique.

Second Preferred Embodiment

In order to perform positioning in traveling direction Z, it is not essential that a positioner that abuts the planes liar and 11br of the vertical support pair 11 is such a plate-like as the positioner 39.

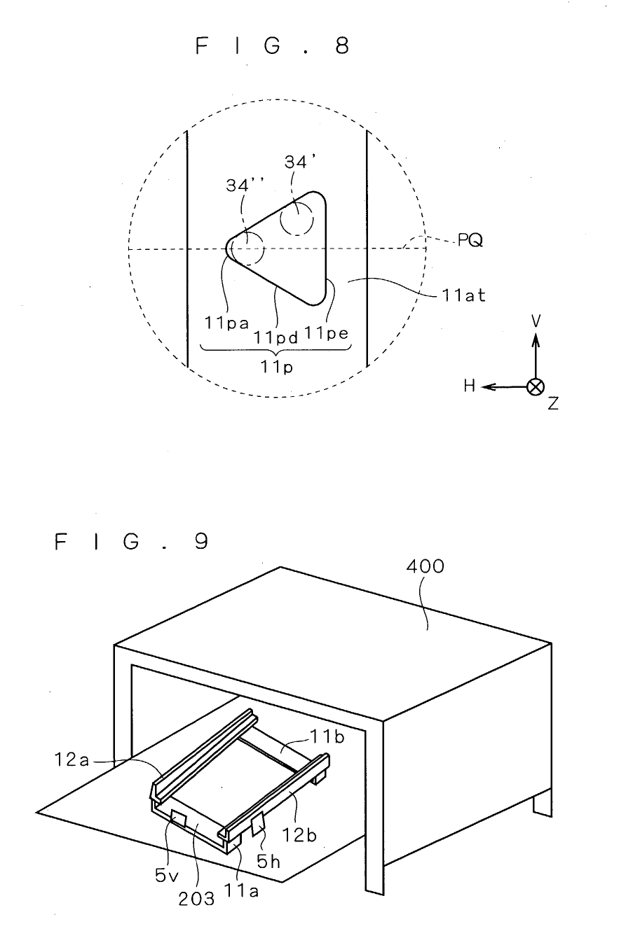

FIG. 7 is a conceptual diagram showing positioning of the support frame structure 202 in traveling direction Z according to a second preferred embodiment of the present invention. The second preferred embodiment employs positioners 38a to 38c, as shown in FIG. 7. The positioner 38a abuts a plane 11ar of the vertical support body 11a when the structure 202 is positioned in traveling direction Z. The positioners 38b and 38c abut a plane 11br of the vertical support body 11b when the structure 202 is positioned in traveling direction Z. Thus, other shape and construction may be employed as far as the movement of the support frame structure 202 in traveling direction Z is stopped when it abuts the planes 11ar and 11br of vertical support pair 11, without disturbing positioning in horizontal direction H and the vertical direction V, prior to positioning in traveling direction Z.

Third Preferred Embodiment

FIG. 8 shows the construction of a support frame structure 202 according to a third preferred embodiment of the invention, which corresponds to the enlarged view of the part III in FIG. 2. In the third preferred embodiment, the contour of a positioning hole 11p is of an approximately triangle and has the circular arc part 11pa shown in the first preferred embodiment, a side 11pe opposed to the circular arc part 11pa, and a pair of sides 11pd joining the circular arc part 11pa and the side 11pe. The circular arc part 11pa is opposed to the side 11pe on the opposite side to the vertical support body 11b, and the side 11pe is disposed nearly vertically to a virtual line PQ. For example, the contour of the positioning hole 11p has an equilateral triangle of which base is the side 11pe. The positioning hole 11q is formed in the same shape as the positioning hole 11p.

As compared to the positioning hole 11p described with reference to FIG. 3 in the first preferred embodiment, the side 11pe extending rather in vertical direction V than the circular arc part 11pc is provided in the third preferred embodiment. This allows a large room in vertical direction V for the location at which the positioning pins 34 and 36 are engaged in the positioning holes 11p and 11q, respectively, as illustrated in position 34′ in FIG. 8. Therefore, as compared with the first preferred embodiment, it is easier to engage the positioning pins 34 and 36 in the positioning holes 11p and 11q.

In the state that the positioning pins 34 and 36 are engaged in the positioning holes 11p and 11q, respectively, the positioning pins 34 and 36 move so as to depart from each other in a direction parallel to horizontal direction H. At this time, the positioning pin 34 is guided to the circular arc part 11pc by the side 11pd, and then abuts the circular arc part 11pc. Alternatively, the positioning pin 34 abuts the paired sides 11pd, respectively. In the latter case, the shape of the circular arc part 11pc may be other than a circular arc, e.g., corner. That is, the end part opposed to the side 11pe may be the circular arc part 11pc or a corner part.

With the above construction, it is possible to perform a stable, reliable and accurate positioning of the support frame structure 202 in horizontal direction H and vertical direction V.

In an alternative, the positioning hole 11p may have the construction of the third preferred embodiment and the positioning hole 11q may have the construction of the first preferred embodiment.

Fourth Preferred Embodiment

FIG. 9 is a conceptual diagram showing a method of manufacturing a color selection structure according to a fourth preferred embodiment of the present invention. Before a support frame structure 203 supports a color selection electrode, the structure 203 is placed in a heat treating furnace 400, followed by a predetermined heat treatment. The heat treatment conditions differ depending on the material of the support frame structure 203. For example, when it is made of precipitation hardened stainless steel, annealing at a temperature around 500° C. increases its mechanical strength. This also eliminates internal strain occurred when the material is cut, bent, or welded in the steps of manufacturing the support frame structure 203.

To reduce the weight of the support frame structure 203, it can be constructed by using a metal plate having a thickness of not more than 2.0 mm, e.g., 1.5 to 2.0 mm. As in the case with the support frame structures 201 and 202, the support fame structure 203 has horizontal support bodies 12a and 12b supporting a color selection electrode, and vertical support bodies 11a and 11b that support the horizontal support bodies 12a and 12b by for example fixing by welding. FIG. 9 illustrates a state that spring holders 5h and 5v to be described later are attached to the horizontal support body 12b and vertical support body 11a, respectively.

In this preferred embodiment, the horizontal support bodies 12a and 12b have an L-shape cross section and extends in horizontal direction H, and they can be formed by bending a metal plate. The vertical support bodies 11a and 11b extend in vertical direction, while their end parts are curved to the horizontal support bodies 12a and 12b. The vertical support bodies 11a and 11b are welded at these end parts to the respective planes of the horizontal support bodies 12a and 12b. That is, the side surfaces of the vertical support bodies 11a and 11b when viewed from horizontal direction H are in U shape opening to the horizontal support bodies 12a and 12b. The vertical support bodies 11a and 11b can also be formed by bending a metal plate.

As described above, the heat treatment to the support frame structure 203 before supporting the color selection electrode increases the mechanical strength of the structure 203. Therefore, the horizontal support bodies 12a and 12b and vertical support bodies 11a and 1b in the support frame structure 203 can be formed by using a thin metal plate. In order to further increase the mechanical strength, the horizontal support bodies 12a, 12b and vertical support bodies 11a, 11b are preferably subjected to bending.

In an alternative, the positioning holes 11p and 11q described in the first or third preferred embodiment may be disposed in a region of the vertical support bodies 11a and 11b which extends in vertical direction. In other alternative, the positioning in traveling direction Z may be performed by bringing the positioners 39, 38a to 38c described in the first or second preferred embodiment into abutment on the above-mentioned region.

Fifth Preferred Embodiment

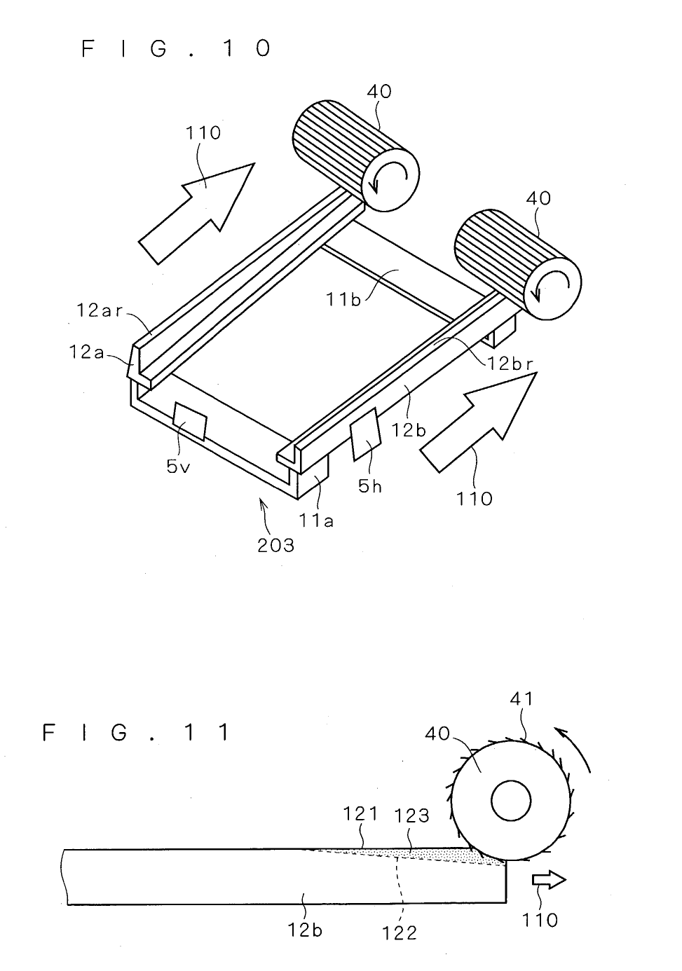

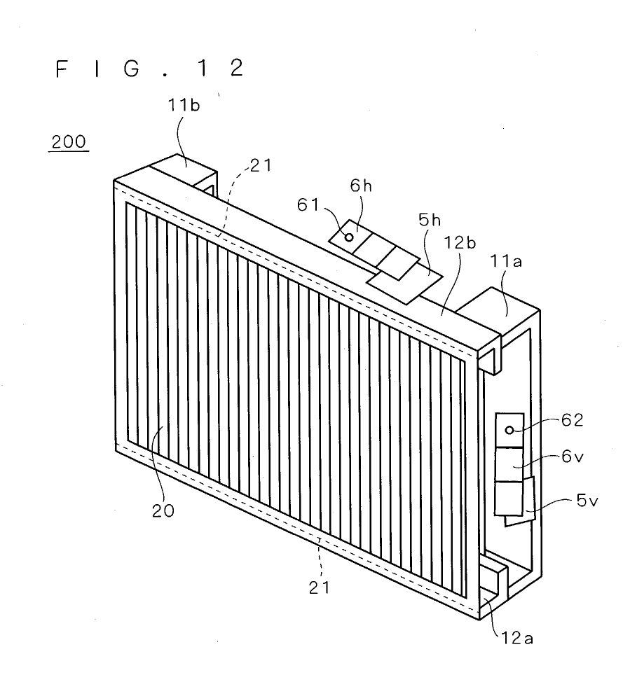

FIGS. 10 and 11 are conceptual diagrams showing a method of manufacturing a color selection structure according to a fifth preferred embodiment of the present invention. Although the heat treatment described in the fourth preferred embodiment enables to enforce the material, in some cases a desired frame structure shape could not be obtained due to thermal deformation. In particular, a high dimensional accuracy is required for planes 12ar and 12br of horizontal support bodies 12a and 12b, which are the remotest from vertical support bodies 11a and 11b, are planes supporting a color selection electrode by welding (hereinafter referred to as “electrode welding plane”). The electrode welding planes 12ar and 12br are generally a curvature and, when its shape does not match a design value, the color selection electrode supported by the support frame structure 203 suffers from dislocation in its hole, slot, or slit. This dislocation deteriorates the purity of a cathode ray tube screen.

To overcome this problem, in the fifth preferred embodiment the shape of the electrode welding planes 12ar and 12br is adjusted by cutting or polishing them by a cutting and polishing machine 40 (hereinafter referred to simply as “cut/polish processing”), as shown in FIGS. 10 and 11. For example, the support frame structure 203 moves to the cutting and polishing machine 40 approximately in direction 110 in which the horizontal support bodies 12a and 12b extend, while the planes 12ar and 12br are faced to the machine 40. The machine 40 has, for example, an approximately cylindrical shape and rotates around an axis approximately parallel to the direction in which the vertical support bodies 11a and 11b extend.

FIG. 11 is an enlarged view showing how the cut/polish processing is carried out, which is also a side view when viewed from a direction parallel to the axis of rotation of the cutting and polishing machine 40. The machine 40 has a blade 41 and rotates in a direction in which the support frame structure 203 is moved in direction 110. Reference numerals 121 and 122 designate a shape before cut/polish processing and a shape after cut/polish processing, respectively. Reference numeral 123 designates a region to be removed by cut/polish processing. The machine 40 may be of rotation type or other suitable type.

Thus, if the shape of the electrode welding planes 12ar and 12br is unsuitable, it can be adjusted by cut/polish processing, thereby obtaining a suitable curved surface of the electrode welding plane in the support frame structure 203. In addition, there is a merit that if any material disturbing welding, e.g., an oxide film, is present on the electrode welding planes 12ar and 12br, it can be removed at that time. In order that the quality of the support frame structure 203 is always stable, it is desirable to perform total inspection of the condition of the electrode welding planes 12ar and 12br.

With the support frame structure 203 obtained by the method of the fourth preferred embodiment or obtained further using the method of the fifth preferred embodiment, a color selection structure can be manufactured by subjecting an aperture grill 20 to seam welding along a track 21 in the same manner as the conventional technique.

The technique described in the foregoing first to fifth preferred embodiments is also applicable to a color selection structure having a shadow mask obtained by a technique other than stretch mask technique.

<Manufacture of Cathode Ray Tube>

The color selection structure based on the technique described in the first to fifth preferred embodiments can be incorporated into a cathode ray tube.

It is desirable to subject the color selection structure, before incorporating into a cathode ray tube, to processing in which heat treatment is conducted in an oxidation atmosphere so as to form an oxide film on its surface (i.e., “blackening”). The reason for this is to prevent rust and improve heat radiation property.

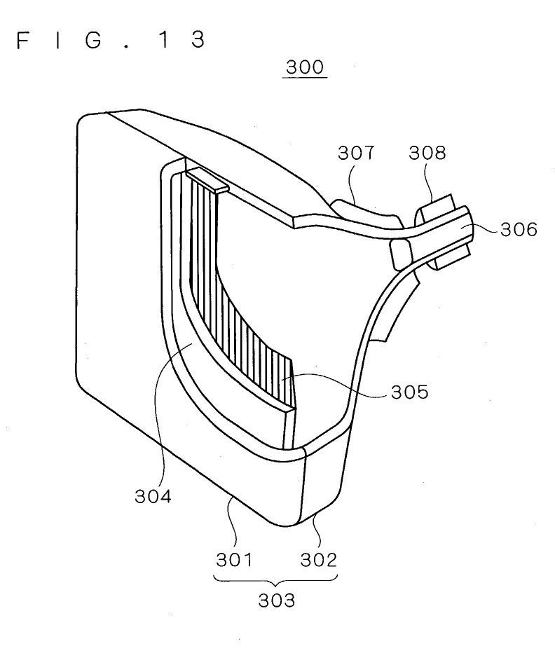

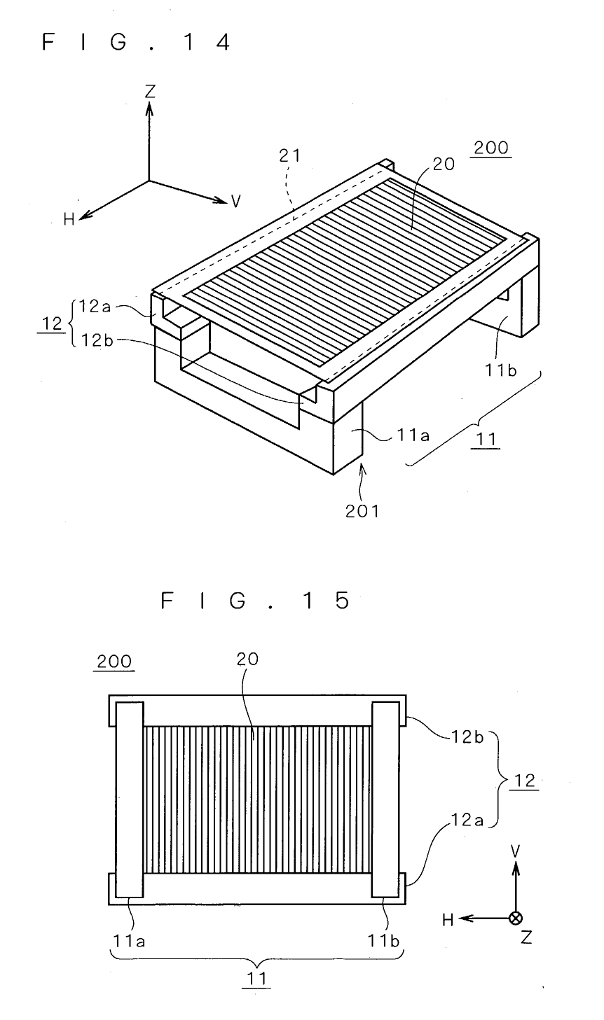

FIG. 12 is a perspective view showing in more detail the construction of a color selection structure 200 than in the first to fifth preferred embodiments. Specifically, FIG. 12 shows the case that an aperture grill 20 is employed as a color selection electrode. Spring holders 5h and 5v are attached to horizontal support body 12b and vertical support body 11a, respectively, and springs 6h and 6v are attached through the spring holders 5h and 5v, respectively.

FIG. 13 is a perspective view, partially broken away for showing a rough internal arrangement, of a cathode ray tube 300 having a color selection structure including a support frame structure of the present invention, or a color selection structure obtained by a method of manufacturing a color selection structure of the present invention.

The cathode ray tube 300 has a glass bulb 303 including a front face panel 301 and a rear funnel 302. In the inside of the glass bulb 303, a phosphor 304, a color selection structure 305, and an electron gun 306 are disposed in the order of increasing the distance from the front face panel 301. The color selection structure 200 can be used as the color selection structure 305. In the glass bulb 303, pins (not shown) are disposed which are engaged in mounting holes 61 and 62 provided in the springs 6h and 6v shown in FIG. 12, respectively. Thereby, the color selection structure 200 as the color selection structure 305 is supported by and fixed to the inside of the glass bulb 303.

A magnet 308 for improving convergence and purity is disposed around the rear funnel 302 locating in the vicinity of the electron gun 306. A deflection yoke 307 is disposed around the rear funnel 302 locating at a region apart from the electron gun 306 to the front face panel 301 side.

Electron beam from the electron gun 306 is irradiated to the phosphor 304 through the color selection structure. More specifically, the electron beam passing through the color selection electrode, e.g., the slit of the aperture grill 20 or the hole or slot of a shadow mask obtained by a technique other than stretch mask technique, is irradiated to the phosphor 304.

The lightening of the cathode ray tube 300 is attainable while maintaining its good quality by using, as the color selection structure 305, the color selection structure including the support frame structure of the present invention, or the color selection structure obtained by the method of manufacturing a color selection structure of the present invention.

While the invention has been shown and described in detail, the foregoing description is in all aspects illustrative and not restrictive. It is therefore understood that numerous modifications and variations can be devised without departing from the scope of the invention.

What is claimed is:

1. A support frame structure that supports a color selection electrode for cathode ray tube in first and second directions orthogonal to each other, said support frame structure comprising:
a first direction support pair supporting said color selection electrode in said first direction; and
a second direction support pair supporting said first direction support pair,
said first direction support pair having a pair of first direction support bodies extending in said first direction,
said second direction support pair having a pair of second direction support bodies extending in said second direction,
each of said second support bodies having a hole, and
a pair of said holes being disposed in said first direction.

2. The support frame structure according to claim 1 wherein
the contour of said hole of one said second direction support body has:
a linear part extending in said first direction; and
a circular arc part joining said linear part on the opposite side to the other said second direction support body.

3. The support frame structure according to claim 1 wherein
the contour of said hole of one said second direction support body has:
a first side approximately vertical to said first direction;
an end part opposed to said first side on the opposite side to the other said second direction support body; and
a pair of second sides joining said end part and both ends of said first side.

4. The support frame structure according to claim 1 wherein each of said pair of first support bodies has:
first and second planes vertical to a third direction orthogonal to said first and second directions; and
a third plane vertical to said second direction,
said first plane, said third plane and said second plane being joined in this order named,
each of said pair of second direction support bodies has:
first and second planes vertical to said third direction; and
a third plane vertical to said first direction,
said first plane, said third plane and said second plane being joined in this order named,
each of said second planes of said pair of first direction bodies being supported by said first planes of said pair of second direction support bodies, and
said holes being disposed on said second planes of said pair of second direction support bodies.

5. The support frame structure according to claim 2 wherein each of said pair of first support bodies has:
first and second planes vertical to a third direction orthogonal to said first and second directions; and
a third plane vertical to said second direction,
said first plane, said third plane and said second plane being joined in this order named,
each of said pair of second direction support bodies has:
first and second planes vertical to said third direction; and
a third plane vertical to said first direction,
said first plane, said third plane and said second plane being joined in this order named,
said second planes of said pair of first direction bodies being supported by said first planes of said pair of second direction support bodies, and
said holes being disposed on said second planes of said pair of second direction support bodies.

6. The support frame structure according to claim 3 wherein each of said pair of first support bodies has:
first and second planes vertical to a third direction orthogonal to said first and second directions; and
a third plane vertical to said second direction,
said first plane, said third plane and said second plane being joined in this order named,
each of said pair of second direction support bodies has:
first and second planes vertical to said third direction; and
a third plane vertical to said first direction,
said first plane, said third plane and said second plane being joined in this order named,
said second planes of said pair of first direction bodies being supported by said first planes of said pair of second direction support bodies, and
said holes being disposed on said second planes of said pair of second direction support bodies.

7. The support frame structure according to claim 4 wherein
each of said pair of first direction support bodies further has a fourth plane that is parallel to said first direction and tilts in said second and third directions,
said first plane, said third plane, said second plane, and said fourth plane are joined in this order named,
said fourth plane being supported by said third plane on the opposite side to said second plane.

8. The support frame structure according to claim 5 wherein each of said pair of first direction support bodies further has a fourth plane that is parallel to said first direction and tilts in said second and third directions, said first plane, said third plane, said second plane, and said fourth plane are joined in this order named, said fourth plane being supported by said third plane on the opposite side to said second plane.

9. The support frame structure according to claim 6 wherein
each of said pair of first direction support bodies further has a fourth plane that is parallel to said first direction and tilts in said second and third directions,
said first plane, said third plane, said second plane, and said fourth plane are joined in this order named,
said fourth plane being supported by said third plane on the opposite side to said second plane.

10. The support frame structure according to claim 1 wherein
each of said pair of first direction support bodies has an L-shape cross section and extends in said first direction, and
each of said pair of second direction support bodies extends in said second direction and their end parts are curved to said first direction support bodies so as to support said first direction support bodies at said end parts.

11. The support frame structure according to claim 2 wherein
each of said pair of first direction support bodies has an L-shape cross section and extends in said first direction, and
each of said pair of second direction support bodies extends in said second direction and their end parts are curved to said first direction support bodies so as to support said first direction support bodies at said end parts.

12. The support frame structure according to claim 3 wherein
each of said pair of first direction support bodies has an L-shape cross section and extends in said first direction, and
each of said pair of second direction support bodies extends in said second direction and their end parts are curved to said first direction support bodies so as to support said first direction support bodies at said end parts.

13. A method of manufacturing a color selection structure including a color selection electrode for cathode ray tube and a support frame structure supporting said color selection electrode,
said support frame structure having:
a first direction support pair supporting said color selection electrode in a first direction; and
a second direction support pair supporting said first direction support pair,
said first direction support pair having a pair of first direction support bodies extending in said first direction,
said second direction support pair having a pair of second direction support bodies extending in a second direction orthogonal to said first direction,
each of said pair of second direction support bodies having a hole,
a pair of said holes are disposed in said first direction,
said method comprising the steps of:
(a) engaging a pair of positioning pins in a pair of said holes;
(b) moving, after the step (a), said pair of positioning pins so as to depart from each other in a direction parallel to said first direction; and
(c) allowing, after the step (b), said first planes of said first direction support bodies to support said color selection electrode.

14. The method according to claim 13 further comprising the step of:
(d) moving, between the step (b) and the step (c), said support frame structure in said third direction until said first planes of said second direction support bodies abuts a positioner.

15. A method of manufacturing a color selection structure comprising the steps of:
(a) annealing a support frame structure; and
(b) allowing, after the step (a), said support frame structure to support a color selection electrode for cathode ray tube.

16. The method according to claim 15 further comprising the step of:
(c) cutting/polishing, between the step (a) and the step (b), a plane supporting said color selection electrode of said support frame structure.

17. A cathode ray tube comprising:
a color selection structure including a color selection electrode for cathode ray tube and a support frame structure supporting said color selection electrode;
a phosphor; and
an electron gun that irradiates electron beam to said phosphor through said color selection structure, said support frame structure comprising:
a first direction support pair supporting said color selection electrode in a first direction; and
a second direction support pair supporting said first direction support pair,
said first direction support pair having a pair of first direction support bodies extending in said first direction,
said second direction support pair having a pair of second direction support bodies extending in a second direction orthogonal to said first direction,
each of said pair of second direction support bodies having a hole,
a pair of said holes being disposed in said first direction.

18. A method of manufacturing a cathode ray tube having a color selection structure including a color selection electrode for cathode ray tube and a support frame structure supporting said color selection electrode; a phosphor; and an electron gun that irradiates electron beam to said phosphor through said color selection structure,
said support frame structure including a first direction support pair supporting said color selection electrode in a first direction, and a second direction support pair supporting said first direction support pair,
said first direction support pair having a pair of first direction support bodies extending in said first direction,
said second direction support pair having a pair of second direction support bodies extending in a second direction orthogonal to said first direction,
each of said pair of second direction support bodies having a hole,
a pair of said holes being disposed in said first direction, said method comprising the steps of:
(a) engaging a pair of positioning pins in said pair of holes;
(b) moving, after the step (a), said pair of positioning pins so as to depart from each other in a direction parallel to said first direction; and
(c) allowing, after the step (b), said first plane of said first direction support bodies to support said color selection electrode.

19. A method of manufacturing a cathode ray tube having a color selection structure including a color selection electrode for cathode ray tube and a support frame structure supporting said color selection electrode; a phosphor; and an electron gun that irradiates electron beam to said phosphor through said color selection structure,
said-method comprising the steps of:
(a) annealing said support frame structure; and
(b) allowing, after the step (b), said support frame structure to support said color selection electrode.
